(19) United States
(12) Patent Application Publication
(10) Pub. No.: US 2023/0071338 A1
(43) Pub. Date: Mar. 9, 2023

(54) NAVIGATION BY MIMIC AUTONOMY

(71) Applicant: Sea Machines Robotics, Inc., Boston, MA (US)

(72) Inventor: Michael Gordon Johnson, Boston, MA (US)

(21) Appl. No.: 17/469,405

(22) Filed: Sep. 8, 2021

(51) Int. Cl. G05D 1/02; G06F 3/0482; G06F 3/0484; B63B 79/40; B63B 79/10; B63B 49/00

(52) U.S. Cl. CPC G05D 1/0208; G06F 3/0482; G06F 3/0484; B63B 79/40; B63B 79/10; B63B 49/00

(57) ABSTRACT

A journey through a waterway along which a sea-faring vessel manually piloted is identified and stored. A second vessel is later autonomously navigated along the same journey based on the stored data.

### BACKGROUND

A wide variety of techniques exist to enable sea-faring vessels to navigate autonomously. However, few if any of these techniques can be successfully relied upon to safely navigate a sea-faring vessel on complete voyages from start to finish. Some voyages are ill-suited for autonomous navigation due to unusual environmental conditions, limitations on the sea-faring vessel's sensor capabilities, local navigation customs, or other reasons.

### SUMMARY

In general, in one aspect, identifying, in real time, a journey through a waterway along which a first marine vessel is manually being piloted during a first time interval; storing the journey on a data storage medium; and during a second time interval, autonomously piloting a second marine vessel along the journey based on the stored journey.

Implementations may have one or more of the following features: the journey includes a time series of geospatial coordinates; the journey includes a time series of vessel state data corresponding to the first vessel; the first vessel is the same as the second vessel; also providing a user interface allowing a user of the second vessel to select the journey from a list of available journeys; the user interface includes a portion showing a chart of the journey; the user interface allows a user of the second vessel to specify an ordered sequence of points not on the journey, the method further comprising autonomously determining a journey through the waterway through the ordered sequences of points; at least a portion of the journey includes docking the vessel; also autonomously taking a non-navigational action at a pre-determined point of the journey; the non-navigational action is selected from the group consisting of: replaying multimedia content; raising or lowering an anchor; raising or lowering a gate; taking a measurement; and autonomously retrieving, deploying, activating, or deactivating a payload.

In another aspect, a system may include: a journey capture module configured to identify and store, in real time, a journey through a waterway along which a first marine vessel is manually being piloted during a first time interval; and an actuation module configured to, during a second time interval, autonomously pilot a second marine vessel along the journey based on the stored journey.

Implementations may have one or more of the following features: the system may also include a sensor module, in which the journey includes a time series of geospatial coordinates; the system may also include a sensor module, in which the journey includes a time series of vessel state data corresponding to the first vessel; the first vessel is the same as the second vessel; the system may also include a user interface allowing a user of the second vessel to select the journey from a list of available journeys; the user interface includes a portion showing a chart of the journey; the user interface allows a user of the second vessel to specify an ordered sequence of points not on the journey, and the journey may be autonomously determined a through the waterway through the ordered sequences of points; at least a portion of the journey includes docking the vessel; the actuation module is further configured to autonomously take a non-navigational action at a pre-determined point of the journey; the non-navigational action is selected from the group consisting of: replaying multimedia content; raising or lowering an anchor; raising or lowering a gate; taking a measurement; and autonomously retrieving, deploying, activating, or deactivating a payload.

These and other features, aspects, and advantages of the present teachings will become better understood with reference to the following description, examples, and appended claims.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 is an overhead view of a sea-faring vessel in a waterway.

FIG. 2 is a block diagram of an autonomous navigation system.

FIG. 3 is a schematic depiction of a user interface for interacting with a navigation system.

FIG. 4A is a schematic depiction of a user interface for interacting with a navigation system.

FIG. 4B is a schematic depiction of a user interface for interacting with a navigation system.

FIG. 4C is a schematic depiction of a user interface for interacting with a navigation system.

FIG. 5 is a flowchart for capturing a journey.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “about,” “approximately,” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

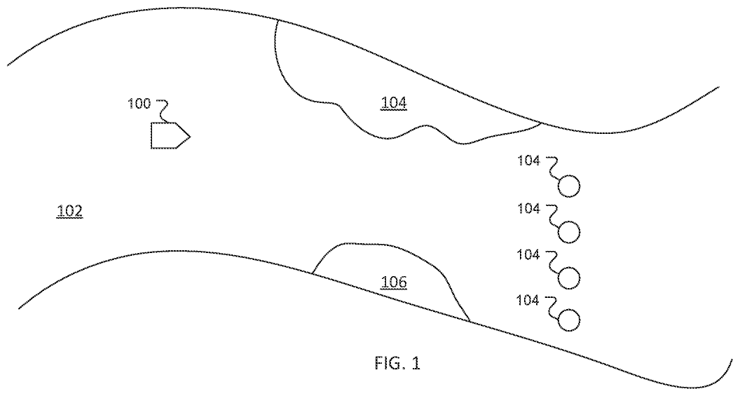

FIG. 1 is an overhead view of a sea-faring vessel in a waterway. The vessel 100 can be any sea faring vessel, including but not limited to small personal vehicles such as a jet ski to large, commercial vessels such as a container ship, among others. As described more fully herein, the vessel 100 includes autonomous navigation equipment. This equipment may include sensors operable to detect some characteristics of the vessel's surroundings, such as water depth, other nearby vessels, etc. The waterway 102 can be any navigable water, including but not limited to lakes, streams, bays, rivers, channels, open ocean, among others.

The waterway 102 includes one or more obstructions 104. An obstruction 104 is an area of the waterway that is unsafe or otherwise undesirable to navigate. An obstruction can include a physical impediment such as a pier or other support of a bridge, an area of shallow water or a vegetation-dense area that is unsafe to navigate through, an unmarked area that, through local custom, is reserved for an exclusive use besides navigation, etc. The term “obstruction” does not include a transient object, such as another vessel 100 navigating the waterway 102. Obstructions refer to objects or areas that substantially remain in place.

Conversely, the waterway 102 may include a point of interest (or region of interest) 106. The point or region of interest can be any location or area that is desirable to navigate to. For example, a point of interest 106 may include an area around an aesthetically pleasing structure, an area close to a shoreline with tall trees whose shade is desirable during hot weather, etc.

Autonomous navigations systems exist that are operable to automatically compute a journey to a desired marine destination from a given start location, or are operable to allow a user to specify a journey through a waterway to a desired destination on a chart. In this document, a “journey” refers to a specific trajectory of a vessel from one point another, including the vessel's speed and orientation between the points. However, a potential journey may take the vessel 100 near obstructions 104 or points of interest 106 that are not clearly delineated on available charts. If the user wants to autonomously avoid such obstructions (or autonomously navigate through such points of interest) using existing systems, the user may have to take their best guess as to where the uncharted obstructions 104 or points of interest 106 are located.

Moreover, autonomous navigation systems exist that allow users to manually override the vessel's traversal of a journey. Thus, a user can suspend autonomous navigation near obstructions 104 or points of interest 106, but this sacrifices the benefits of autonomous navigation.

The techniques described herein may allow a user to accurately specify a desired journey of a sea-faring vessel 100 through a waterway 102, while avoiding obstructions 104 (including uncharted obstructions) or navigating through desired points of interest 106 (including uncharted points of interest).

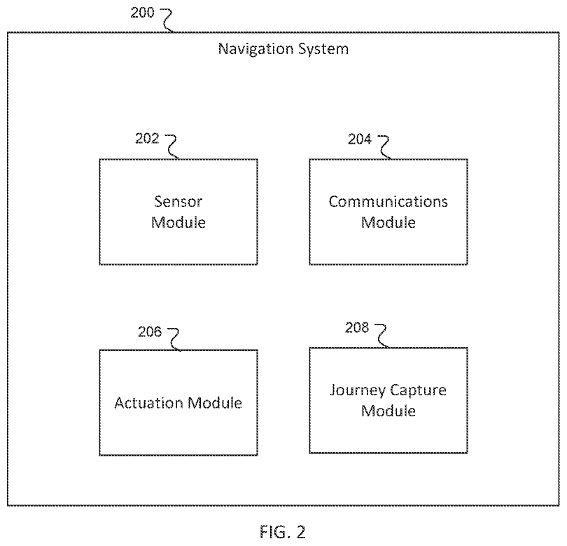

FIG. 2 is a block diagram of an autonomous navigation system. As more fully described below, the autonomous navigation system 200 is operable, among other things, to process sensory input from sensors mounted on a sea-faring vessel or elsewhere, and to use the processed sensory input to provide navigation signals or instructions for a sea-faring vessel to autonomously navigate in a waterway.

The navigation system 200 can be implemented as software, hardware, or a combination of hardware and software. In some implementations, the navigation system 200 is implemented as a standalone computing device (with accompanying software) that may be deployed on “general purpose” sea-faring vessels; that is, vessels that were not specifically designed to accommodate autonomous navigation functionality.

The navigation system 200 includes a sensor module 202. The sensor module 202 is operable to interface with various sensors either onboard a vessel or remote from a vessel. In some implementations, the sensors may include accelerometers and/or gyroscopes. In some implementations, the accelerometers and/or gyroscopes are configured to provide information about the motion of the vessel (or portions thereof). In some implementations, the sensors may include one or more cameras that are configured to acquire still images or video; e.g., images or video of incoming waves or the waters surrounding the vessel. In some implementations, the sensors can include one or more active or passive radio sensing systems, operable to sense the position(s) and/or motion(s) of other nearby vessels or other objects of interest.

In some implementations, the sensors could include one or more Global Navigation Satellite Service (“GNSS”) receivers. Such services include but are not limited to global positioning satellite (“GPS”) receivers, GALILEO, receivers, BeiDou Navigation receivers, GLONASS, receivers, etc. Such receivers are operable to sense the geospatial coordinates (i.e., position) of the vessel with respect to the Earth at a given moment. In some implementations, the navigation system 202 is further capable of performing one or more Simultaneous Localization and Mapping (“SLAM”) algorithms, which are operable to determine coordinates of the vessel based on other information, such as video signals. Such SLAM-determined coordinates are intended to be within the meaning of “geospatial coordinates.” In any case, such coordinates may be useful, e.g., to utilize external localized information, such as characterizations of the waters surrounding the vessel provided by a remote source.

In some implementations, the sensors may include one or more marine Automatic Identification System (“AIS”) receivers, operable to identify MS signals sent by nearby vessels. In some implementations, the sensors may include one or more special-purpose sensors to sense a location with respect to a special-purpose beacon. In some implementations, the sensors may include radar sensors. In some implementations, the sensors include instruments for measuring weather conditions (e.g., one or more anemometers for measuring wind speed; one or more barometers for measuring atmospheric pressure, one or more thermometers for measuring temperature, etc.) In some implementations, the sensor module 202 can include a depth sounder, operable to determine the depth of the water in which the vessel is currently located. Other sensors are possible.

The navigation system 200 includes a communications module 204. The communications module 204 is operable to facilitate communication between the navigation system 200 and external sources, a command station, or destinations. In some implementations, the communications module 204 includes equipment suitable for electronic communications with other equipment, either onboard the vessel or remote from the vessel. In some implementations, the communications module 204 includes one or more antennas suitable for cellular or data communication with other nearby vessels, with points on land, or with orbiting satellites. In some implementations, the communications module 204 includes hardware and/or software resources sufficient to implement data communication, including 3G-, 4G-, WiMax-, or 5G-enabled communication equipment, among other possibilities. In some implementations, the communications module 204 is operable to retrieve weather data for one or more points along the vessel's journey, in addition to or instead of any weather-related onboard sensors in the sensor module 202.

The navigation system 200 includes an actuation module 206. The actuation module 206 is operable to effect changes to the vessel's heading, course, speed, or other navigation-related parameters. This includes implementing a series of changes to the vessel's heading, course, and speed so as to traverse a pre-determined journey, as described more fully herein. In some implementations, the actuation module 206 can include middleware such as MOOS-IvP, maintained by the Massachusetts Institute of Technology as part of the Laboratory for Autonomous Marine Sensing Systems; Robotic Operating System (“ROS”), maintained by Willow Garage, Inc.; and/or Control Architecture for Robotic Agent Command and Sensing (“CARACaS”), maintained by the NASA Jet Propulsion Laboratory.

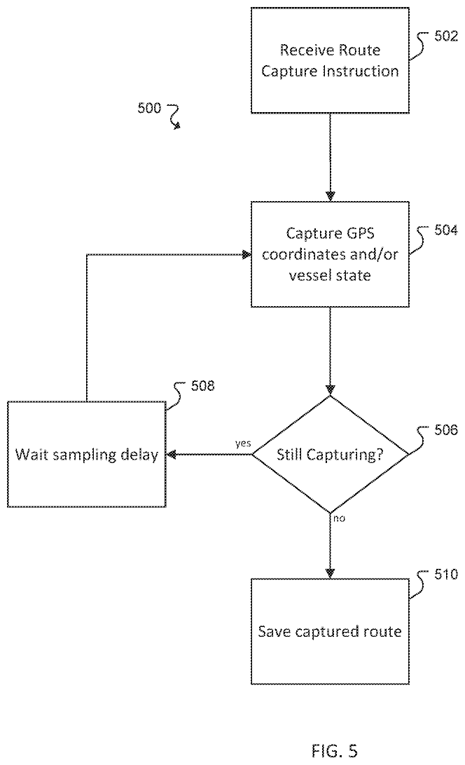

The navigation system 200 includes a journey capture module 208. As described more fully below with respect to FIG. 5, the journey capture module is operable to accept and record changes in a sea-faring vessel's navigational state. The navigational state may include but need not be limited to information such as the vessel's course, speed, heading, and/or the state of the vessel's components, such as its rudder position(s), thrust settings, trim adjustment device settings, engine status information, transmission gear selection, etc.

Other implementations of the navigation system 200 are possible. For example, other implementations are described in U.S. Pat. No. 10,427,908, entitled “Autonomous Boat Design for Tandem Towing,” the entirety of which is incorporated by reference herein.

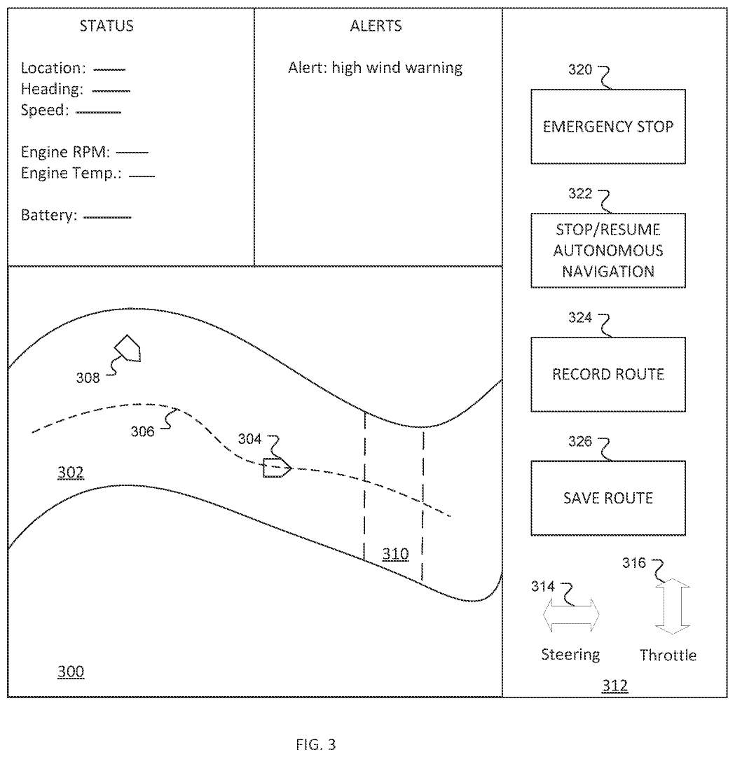

FIG. 3 is a schematic depiction of a user interface for interacting with the navigation system 200. The user interface is depicted as shown on a display. The display may be incorporated into any suitable hardware, including but not limited to: integrated into the navigation hardware of the vessel; on a special-purpose portable device designed to interfacing with the navigation system 200; on a general purpose computer; on a general purpose mobile device, such as a smartphone, tablet, etc.; or other hardware. In some implementations, the display is touch-enabled, allowing a user to specify input directly on the display. In some implementations, the user may input information to the interface using traditional hardware, such as a keyboard, trackball, mouse, etc.

The user interface includes a chart portion 300. The chart portion 300 shows a waterway 302 and the position and orientation of the vessel 304 within the waterway. In some implementations, a journey 306 may have been previously identified along which the vessel 304 is navigating (including but not limited to autonomously navigating). The chart portion 300 may also show other relevant features, such as other vessels 308 or other relevant structures, such as the bridge 310 shown in FIG. 3. Other relevant features include but are not limited to channels, depths, obstructions, markers, buoys, docks, or other structures.

In some implementations, some data used to display at least part of the chart portion 300 is stored, statically, onboard the navigation system 200. In some implementations, other data used to display at least part of the chart portion 300 is detected in real time; e.g., through the sensor module 202 of the navigation system 200. In some implementations, the data used to display at least part of the chart portion 300 comes from another source.

The user interface includes a control area 312. The control area 312 includes a steering control 314 and a throttle control 316. The steering control 314 is operable to alter the vessel's heading in any manner, including but not limited to articulating one or more rudders, changing the output direction of one or more engines propellers (in the case of propeller engines), nozzles (in the case of jet engines), etc. The throttle control 316 is operable to alter the power output of one or more engines on the vessel. Although only one set of controls 314, 316 are shown on the user interface, in general there may be more. For example, vessels that have individually-controllable motors and/or rudders may each have their own corresponding steering and/or throttle control. In some implementations, steering and throttle controls are not provided via the display, but instead are provided via hardware such as joysticks, levers, etc.

The control area 312 also includes various buttons or toggles, including a button 320 to bring the vessel 304 to an immediate halt and shut down the engine(s), a button 322 to stop or resume autonomous navigation, and a button 324 to begin recording a journey. As explained more fully below, when the user activates the “record journey” functionality, the vessel 304 may be piloted manually (either through controls 314 and 316, or in some other way). The navigation system 200 will then capture the journey along which the vessel is manually piloted until the user pressed button 326, which causes the user interface to prompt the user whether to save or discard the recorded journey. If the journey is saved, in some implementations, it is saved locally on hardware implementing the navigation system. In some implementations, it is stored remotely from the navigation system hardware. In some implementations, the journey may be shared with other users. This may facilitate the creation of “guided tours” or other types of curated trips along points of interest that a user may create and share with other users.

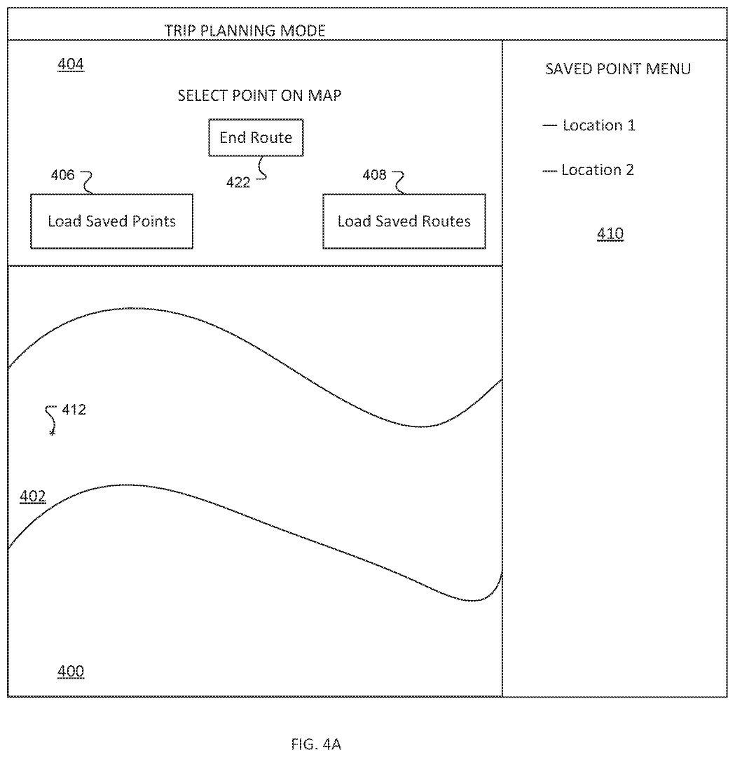

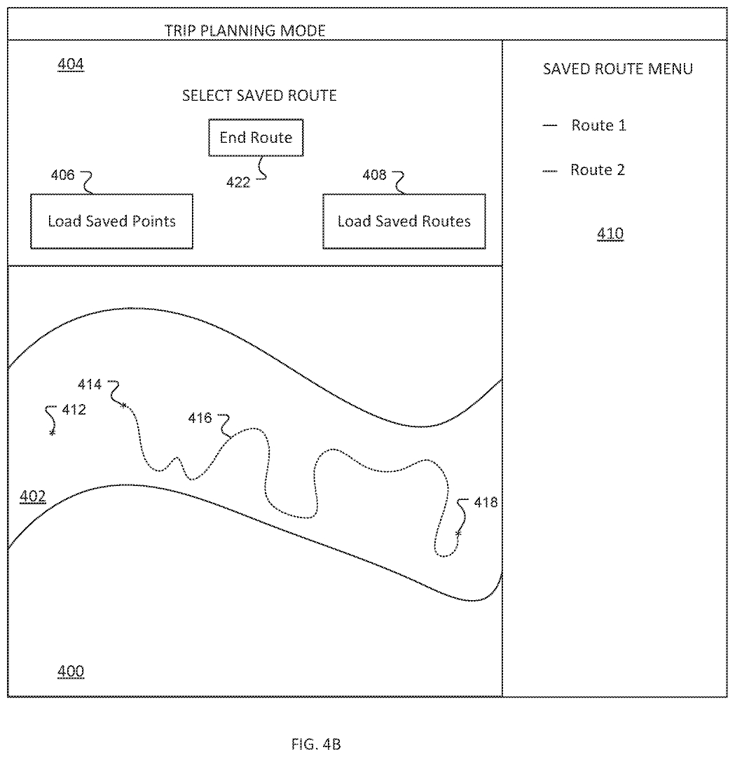

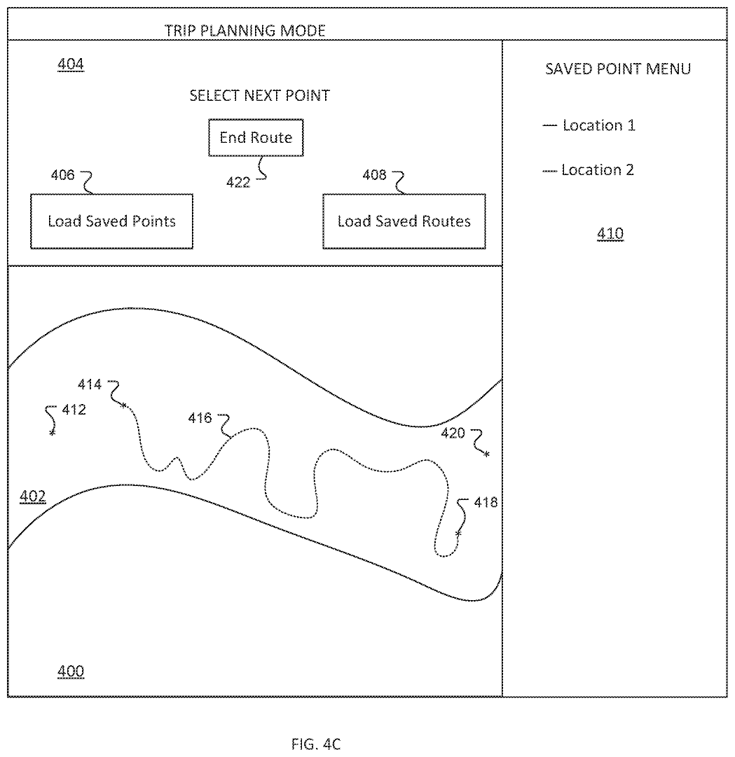

FIGS. 4A-4C further show how the user interface is used to specify journeys for autonomous navigation, in which at least a portion of the journey has previously been captured in the manner described above.

FIG. 4A shows the user interface in “trip planning mode,” in which a chart portion 400 showing a waterway 402 is displayed. The user interface also includes an area 404 in which the user may load saved points via button 406, or load saved journeys via button 408. The saved points and/or saved journeys are listed in area 410, and may also appear in the chart area 400.

Whether by loading a saved point or manually specifying a point, the first point 412 of a journey is specified. In some cases, a journey may be computed from a single specified point (i.e., the destination). If this were the case, the user would activate button 422, thereby causing the navigation system to save the specified journey. However, a journey may generally be specified by selecting multiple points.

FIG. 4B shows the user interface after further selecting a pre-defined journey, such as a journey recorded as described herein. The journey 416 includes a starting point 414 and an end point 418. By including the pre-defined journey 416 as shown, the user is relying on the navigation system to compute how to navigate from point 412 (the first specified point on the journey) to point 414 (the starting point of journey 416). Upon arrival at point 414, the vessel will traverse the journey 416 as previously recorded, until finally reaching point 418.

FIG. 4C shows the user interface after further specifying an additional point 420, after the vessel completes its trip along journey 416. In this example, the user specified points 412, 414, 418, and 420. The navigation system will compute a path for the vessel to travel from point 412 to 414. Then, the navigation system will “replay” the journey 416, rather than autonomously compute a path from point 414 to 418. Finally, the navigation system will again compute a path to autonomously navigate from point 418 to point 420.

In some implementations, some degree of autonomous navigation is permitted even when traversing a manually-recorded path, such as path 416. For example, autonomous collision-avoidance functionality or other autonomous safety features are known in the art. These features may still be active while traversing a recorded path, such as path 416.

FIG. 5 is a flowchart for capturing a journey. The method 500 may be employed by the journey capture module in combination with other modules of the navigation system, for example, when a user selects the “record journey” button on the user interface in FIG. 3. Whether through the interface of FIG. 3 or some other way, the method 500 begins with receiving a journey capture instruction (step 502). The geospatial coordinates, speed, heading, and direction, and/or other vessel state information is then captured (step 504). In some implementations, the geospatial coordinates are captured by the sensor module of the navigation system. The “vessel state” can include the current state of components pertinent to navigation; i.e., the engine settings (including output and/or direction), as well as the positions of any fins, rudders, nozzles, or other navigational surfaces and/or components of the vessel. “Capturing” this information includes storing the information on a data storage medium, along with a time stamp, indicating the moment at which the information describes the state of the vessel.

If the vessel is still in “journey capture mode” (decision 506), then the method 500 proceeds by waiting a delay time (step 508) before capturing and storing a next set of geospatial coordinates/vessel state data. In some implementations, the delay time is between 1/50 seconds and 1/20 seconds. In some implementations, the delay time is chosen to match the sampling frequency of an onboard GNSS receiver. By continuously iterating loop 504-506-508 while the vessel is being manually piloted, the method 500 produces a time series of geospatial coordinate data and/or vessel state information that, collectively, describes a pre-recorded path that the vessel (or other vessels) may traverse in the future.

When the decision is made to cease capturing (decision 506), the time series of geospatial coordinate data and/or vessel state information is stored (step 510). In some implementations, this data is stored onboard the navigation system. In some implementations, this data is stored remotely from the navigation system.

The techniques described above may be extended beyond mere navigation. It may be desirable to take certain non-navigational actions along a journey, depending on the purpose of that journey. These non-navigational actions can be replayed at the location(s) along a journey at which the actions originally occurred. Without limiting the scope of this extension, the following examples are illustrative.

In one example, the vessel can include a ferry for transporting passengers or cargo between locations. In this case, it may be desirable to capture and autonomously replay non-navigational actions such as raising or lowering gates to the vessel, opening or closing doors, sounding an alarm or a pre-recorded message (e.g., “we are approaching the end of our journey, please return to your seats”), etc.

In another example, the vessel can include a commercial fishing vessel. In this case, it may be desirable to capture and autonomously replay non-navigational actions such as deploying or retrieving fishing equipment, such as nets, lines, traps, etc. More generally, it can be desirable for any vessel to deploy, retrieve, activate, or deactivate a payload at one or more pre-determined points along a journey.

In yet another example, any type of vessel can include a non-navigational action involving the replay of multimedia content. One use case of this functionality includes allowing various users to make and share “guided tours” of waterways. That is, a tour creator may manually navigate a vessel along a journey, stopping at various points of interest to record (or subsequently provide) multimedia content (e.g., multimedia content relevant to the point of interest). Later, a person taking the tour would board a vessel that autonomously navigates the original journey, and plays back the multimedia content when the vessel reaches the specified point in the journey.

In yet another example, the vessel can include a surveillance or patrol vessel. In this case, it may be desirable to capture and autonomously replay non-navigational actions such as acquiring a video recording, camera image, radar image, etc., and to send that image to a pre-determined remote location over a communication channel.

In yet another example, the vessel can include a research vessel, and the non-navigational action can include performing a research-related measurement, such as measuring a water or air temperature, measuring a water column, acquiring a video, radar, or audio recording, etc., and sending the measurement to a pre-determined remote location over a communication channel.

The methods, components, modules, or other approaches described above may be implemented in software, or in hardware, or a combination of hardware and software. The software may include instructions stored on a non-transitory machine-readable medium, and when executed on a general-purpose or a special-purpose processor implements some or all of the steps summarized above. The hardware may include Application-Specific Integrated Circuits (ASICs), Field Programmable Gate Arrays (FPGAs), and the like. The hardware may be represented in a design structure. For example, the design structure comprises a computer accessible non-transitory storage medium that includes a database representative of some or all of the components of a system embodying the steps summarized above. Generally, the database representative of the system may be a database or other data structure which can be read by a program and used, directly or indirectly, to fabricate the hardware comprising the system. For example, the database may be a behavioral-level description or register-transfer level (RTL) description of the hardware functionality in a high-level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the system. The netlist may then be placed and routed to produce a data set describing geometric shapes to be applied to masks. The masks may then be used in various semiconductor fabrication steps to produce a semiconductor circuit or circuits corresponding to the system. In other examples, alternatively, the database may itself be the netlist (with or without the synthesis library) or the data set.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application-specific integrated circuits, programmable gate arrays, programmable array logic components, or any other device or devices that may be configured to process electronic signals. It will further be appreciated that a realization of the processes or devices described above may include computer-executable code created using a structured programming language such as C, an object-oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionalities may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory, or any other optical, electromagnetic, magnetic, infrared, or other device or combination of devices. In another aspect, any of the systems and methods described above may be embodied in any suitable transmission or propagation medium carrying computer-executable code and/or any inputs or outputs from the same.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings.

Unless the context clearly requires otherwise, throughout the description, the words “comprise,” “comprising,” “include,” “including,” and the like are to be construed in an inclusive sense as opposed to an exclusive or exhaustive sense; that is to say, in a sense of “including, but not limited to.” Additionally, the words “herein,” “hereunder,” “above,” “below,” and words of similar import refer to this application as a whole and not to any particular portions of this application.

It will be appreciated that the devices, systems, and methods described above are set forth by way of example and not of limitation. For example, regarding the methods provided above, absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computing) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

1. A method, comprising:
identifying, in real time, a journey through a waterway along which a first marine vessel is manually being piloted during a first time interval;
storing the journey on a data storage medium; and
during a second time interval, autonomously piloting a second marine vessel along the journey based on the stored journey, in which the second marine vessel is different from the first marine vessel.

2. The method of claim 1, in which the journey includes a time series of geospatial coordinates.

3. The method of claim 1, in which the journey includes a time series of vessel state data corresponding to the first marine vessel.

4. The method of claim 1, in which the first marine vessel is the same as the second marine vessel.

5. The method of claim 1, further including providing a user interface allowing a user of the second marine vessel to select the journey from a list of available journeys.

6. The method of claim 5, in which the user interface includes a portion showing a chart of the journey.

7. The method of claim 5, in which the user interface allows the user of the second marine vessel to specify an ordered sequence of points not on the journey, the method further comprising autonomously determining a journey through the waterway through the ordered sequences of points.

8. The method of claim 1, in which at least a portion of the journey includes docking a vessel.

9. The method of claim 1, further comprising autonomously taking a non-navigational action at a pre-determined point of the journey.

10. The method of claim 9, in which the non-navigational action is selected from the group consisting of: replaying multimedia content; raising or lowering an anchor; raising or lowering a gate; taking a measurement; and autonomously retrieving, deploying, activating, or deactivating a payload.

11. A system comprising:
a journey capture module configured to identify and store, in real time, a journey through a waterway along which a first marine vessel is manually being piloted during a first time interval; and
an actuation module configured to, during a second time interval, autonomously pilot a second marine vessel along the journey based on the stored journey, in which the second marine vessel is different from the first marine vessel.

12. The system of claim 11, further comprising a sensor module, in which the journey includes a time series of geospatial coordinates obtained from the sensor module.

13. The system of claim 11, further comprising a sensor module, in which the journey includes a time series of vessel state data corresponding to the first marine vessel.

14. The system of claim 11, in which the first marine vessel is the same as the second marine vessel.

15. The system of claim 11, further including a user interface allowing a user of the second marine vessel to select the journey from a list of available journeys.

16. The system of claim 15, in which the user interface includes a portion showing a chart of the journey.

17. The system of claim 15, in which the user interface allows the user of the second marine vessel to specify an ordered sequence of points not on the journey, and in which the journey is autonomously determined through the waterway through the ordered sequences of points.

18. The system of claim 11, in which at least a portion of the journey includes docking a vessel.

19. The system of claim 11, in which the actuation module is further configured to autonomously take a non-navigational action at a pre-determined point of the journey.

20. The system of claim 19, in which the non-navigational action is selected from the group consisting of: replaying multimedia content; raising or lowering an anchor; raising or lowering a gate; taking a measurement; and autonomously retrieving, deploying, activating, or deactivating a payload.
